(19) United States
(12) Patent Application Publication
(10) Pub. No.: US 2018/0346304 A1
(43) Pub. Date: Dec. 6, 2018

(54) CORKSCREW WITH LEVER

(71) Applicant: PSP, Quingey (FR)

(72) Inventor: Thierry GOURAND, Bans (FR)

(21) Appl. No.: 15/779,523

(22) PCT Filed: Oct. 21, 2016
(86) PCT No.: PCT/FR2016/052719

§ 371 Date: May 27, 2018

(30) Foreign Application Priority Data
Nov. 30, 2015 (FR) 1561546

(51) Int. Cl. B67B 7/04

(52) U.S. Cl. CPC B67B 7/0429

(57) ABSTRACT

The corkscrew with lever includes a spiral mounted rotating on a zone of a handle between an end segment and a maneuvering segment, and a telescoping arm having a first element mounted rotating on the end segment and a second element, having an upper end and a lower end, mounted sliding in the first element between an idle position and a second position. The lower edge of the lower end of said second element is provided to bear on the neck of a bottle. The end segment defines a circular cam having, as center, the second axis and able to act on the upper end of the second element, which is connected to the second axis using a return member. In a usage position of the corkscrew, its upper end is continuously kept in contact with the cam and its lower end extends continuously outside the first element.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The invention relates to a corkscrew of the type “with lever” including, on the one hand, a spiral mounted rotating on a zone of a handle comprised between an end segment and a maneuvering segment of said handle, around a first axis perpendicular to said sleeve, and on the other hand, a telescoping arm having a first element mounted rotating on the end segment of said handle around a second axis perpendicular to said handle and a second element, having an upper end and a lower end, mounted sliding in said first element between an idle position in which its lower end is located at a distance d0 from said second axis and a second position in which its lower end is located at a distance d from said second axis greater than d0, the lower end of said second element being provided able to bear on the neck of a bottle.

### 2. Description of Related Art Including Information Disclosed Under 37 CFR 1.97 and 37 CFR 1.98

A corkscrew of the type “with lever” traditionally makes it possible to reduce the pulling force that a user must supply to remove a cork after having inserted a spiral therein.

Different categories of corkscrews of this type are currently commercially available, in particular differing from one another by the number of bearings or the number of levers that they include.

The most basic model includes a lever with a fixed length allowing a single bearing on the neck. Such a device nevertheless has limitations at the end of uncorking, when the force to be exerted to remove the cork becomes significant, or in case of cork with a length greater than the standard length. Indeed, the handle of the corkscrew is then placed practically vertically relative to the bottle, and the lever can no longer act, requiring the user to complete the uncorking operation without using it.

Other, more elaborate models have been proposed to offset this drawback.

A corkscrew model is thus known including two separate levers fastened on the same rotation axis and each having a bearing point on the neck of a bottle. Such a structure nevertheless results in a somewhat tedious usage mode, since it requires the user to change the bearing point, and therefore lever point, during the operation. Furthermore, after placing the second lever, it is necessary to pivot the first lever to place it in a position in which it does not risk hindering the operation thereof or bothering the user.

A corkscrew with double bearing has also been considered, having a first lever, including a first bearing, fastened on the handle of the corkscrew, and a second lever, having a second bearing, mounted rotating on the lower end of the first lever. In the same category is also a corkscrew with double bearing described in document FR 2,755,957, which includes a first lever mounted pivoting on the handle and a second lever smaller than the first lever mounted rotating on a central part of the latter. Nevertheless, such corkscrews do not make it possible to resolve the drawbacks mentioned above, since here again, their structure is such that the user is forced to change levers during uncorking, and to pivot one and/or the other of the two levers in order to put it in the usage and idle position.

Furthermore, a corkscrew is also known with a single lever and multiple bearings as described in publication FR 2,772,364, in which the different bearing points are embodied by a row of notches made in a groove of the lever. Such a structure also involves manually changing the bearing point as a cork is removed. Consequently, it is no more satisfactory, in terms of its usage comfort, than the solutions described above.

Document EP 0,860,396 describes another solution in which the corkscrew includes a lever having a first element with a given length connected to the handle and the lower end of which is provided with a bearing point. The lever also has a second element connected to the first element, the lower end of which is also provided with a bearing point and which is movable between a position retracted inside the first element and a position partially removed from the first element. In its retracted position, the upper edge of the second element appears in a window formed in the front face of the first element and in which the head of the handle is able to be inserted during its rotational movement. The movement of the second element toward its position partially removed from the first element results in lengthening the latter. This movement is obtained by the action of the handle being gradually inserted, following its rotation, into the window of the first element and therefore bearing on the upper edge of said second element. Such a structure makes it possible to simplify the implementation of the corkscrew, because there is no longer a need to replace one lever with another or one bearing point with another during the removal of the cork. Nevertheless, it has been observed that the length by which the first element is extended is generally not sufficient to allow the removal of the entire cork using the lever and that the user must generally use his strength alone to ultimately achieve this.

### BRIEF SUMMARY OF THE INVENTION

The present invention aims to offset the aforementioned drawbacks and to propose a solution allowing a user to remove, easily and successfully with each attempt, a cork held in the neck of a bottle. In particular, the invention aims to facilitate the uncorking of bottles by a user using a corkscrew of the type “with lever” making it possible to retain the simplicity of the single bearing, while reducing the force necessary for uncorking and retaining the interest of the corkscrew with multiple bearings, i.e., a different separation of the bearing lever relative to its rotation axis on the handle of the corkscrew depending on the level of insertion of the cork into the bottle. Additionally, the invention also aims to propose a solution making it possible to reduce the number of steps necessary for folding/unfolding of the spiral and the lever, by ensuring that these elements can fold/unfold simultaneously through a single gesture by the user.

To that end, the present invention relates to a corkscrew of the type indicated in the preamble, characterized in that the end segment of said handle is configured so as to define a circular cam having, as center, said second axis and able to act on the upper end of said second element, which is connected to said second axis using a return member such that, in a usage position of the corkscrew, its upper end is continuously kept in contact with said cam and its lower end extends continuously outside said first element.

Other features and advantages of the invention will emerge from the following detailed description relative to one embodiment of the ejection device given solely for information and non-limitingly.

### BRIEF DESCRIPTION OF THE SEVERAL VIEWS OF THE DRAWINGS

The understanding of this description will be facilitated in reference to the attached drawings.

FIG. 1 shows a front elevation view of a corkscrew according to the invention in its usage position in which the spiral and the arms are unfolded.

FIG. 2 is a front elevation view of the handle of the corkscrew of FIG. 1.

FIG. 3 is a bottom plan view of this same handle.

FIG. 4 shows a front elevation view of the spiral of the corkscrew of figure

FIG. 5 is a perspective view of the arm of the corkscrew of FIG. 1.

FIG. 6 is a sectional view across line AA of this same arm.

FIG. 6A is a sectional view across line BB of the first element of this same arm.

FIG. 6B is a sectional view across line CC of the second element of this same arm.

FIG. 7 is a sectional view of detail D of FIG. 1.

FIGS. 8 to 11 show sectional views of the corkscrew of FIG. 1 and the neck of a bottle during different steps of the uncorking of the latter.

FIGS. 12 to 14 are sectional views of the corkscrew of FIG. 1 during different steps of its unfolding,

FIGS. 15 to 17 are sectional views of the corkscrew of FIG. 1 illustrating a first folding mode toward its storage position.

FIGS. 18 to 22 are sectional views of the corkscrew of FIG. 1 illustrating a second folding mode toward its storage position.

### DETAILED DESCRIPTION OF THE INVENTION

It is first specified that in the following description, the arrows E and m shown in some figures respectively represent the forces applied by a user on a component element of the corkscrew 1 according to the invention, and the movement imparted by these forces.

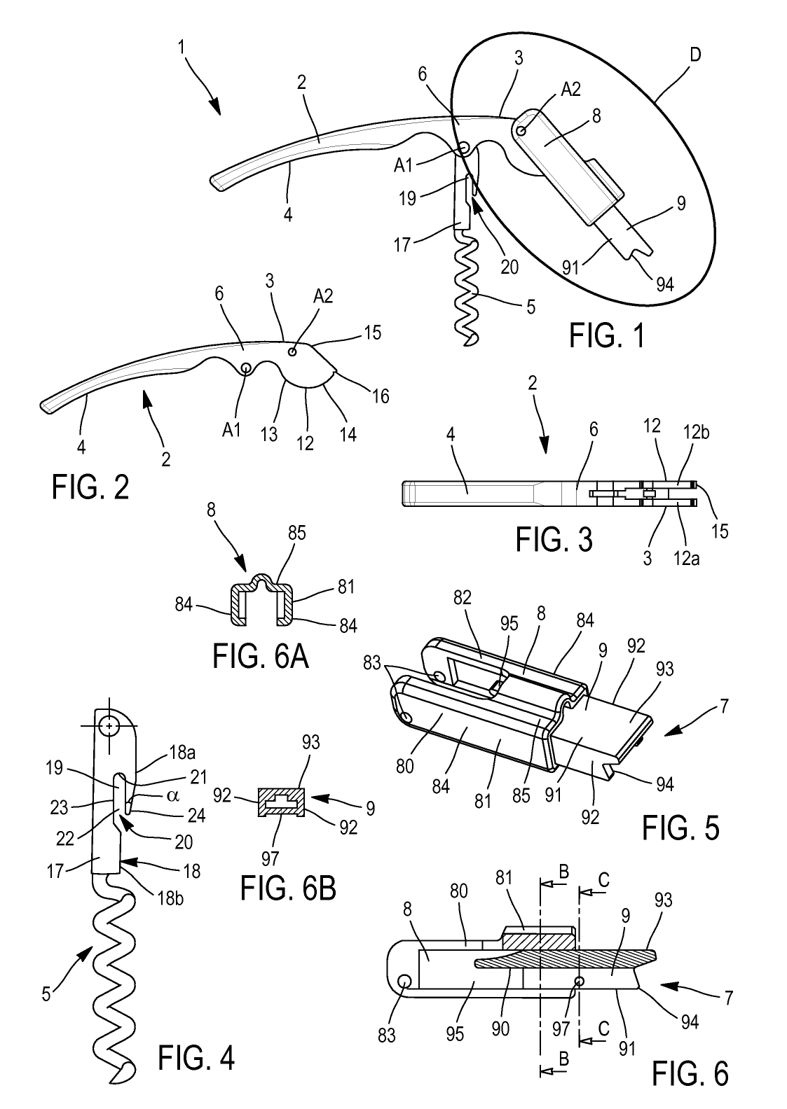

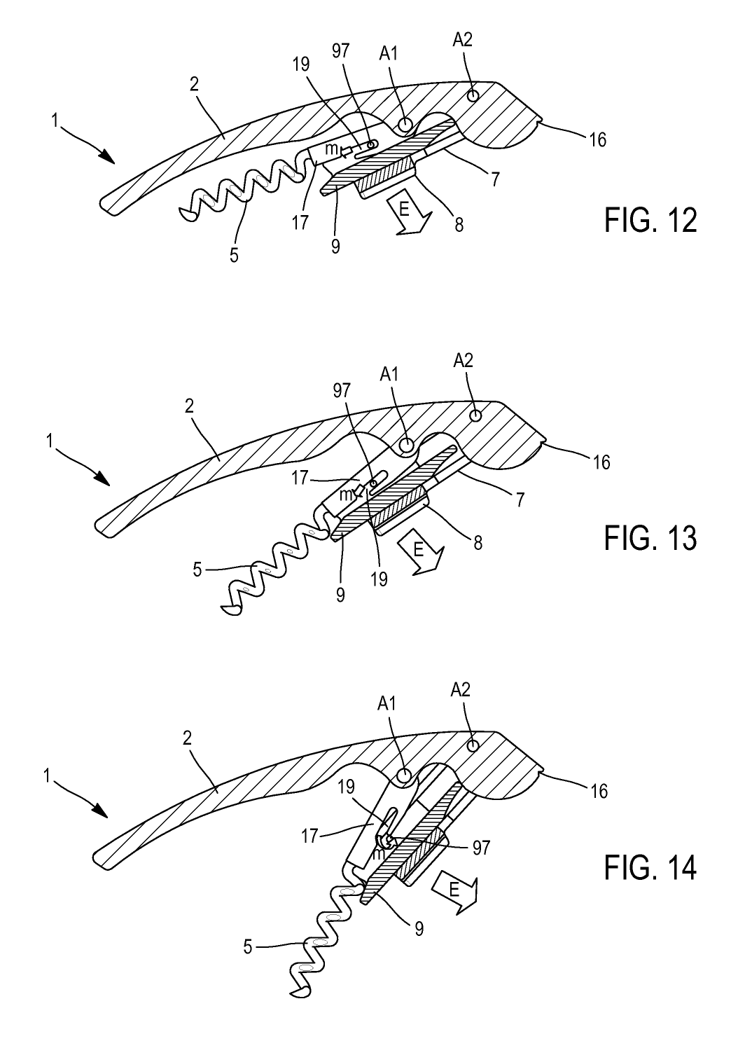

In the alternative embodiment illustrated in the figures, the corkscrew 1 according to the invention includes a handle 2, for example made from wood, metal, plastic, composite material, ceramic or any other equivalent material, having an end segment 3 and a maneuvering segment 4. A metal spiral 5 is mounted rotating around the first axis A1 perpendicular to the handle 2 over an intermediate zone 6 of said handle 2 comprised between its end segment 3 and its maneuvering segment 4. The corkscrew 1 also includes a telescoping arm 7, made from metal, mounted rotating on the end segment 3 of said handle 2 around a second axis A2 perpendicular to said handle 2. Thus, traditionally, the spiral 5 and the telescoping arm 7 are movable between a usage position of the corkscrew 1, in which they are unfolded (FIG. 1), and a storage position of the corkscrew 1, in which they are folded against the lower edge of the handle 2 (FIG. 12).

In reference to FIGS. 5 and 6, the telescoping arm 7 is made up of a first element 8 having an upper part 80 and a lower part 81 and a second element 9, having an upper end 90 and a lower end 91. The lower part 81 of the first element 8 has a C-shaped section and has two L-shaped side walls 84 bordering a face 85. The upper part 80 of the first element 8 includes two tabs 82 extending each of the side walls 84 of the lower part and the respective free end of which includes an orifice 83 allowing the assembly of the telescoping arm 7 on the axis A2 of the handle 2.

The second element 9 of the telescoping arm 7 has an upper end 90 and a lower end 91. It includes two side fins 92 bordering a bottom 93 and with a generally U-shaped section. The lower edge 94 of each of the lateral wings 92 has a V-shaped cutout able to bear on the neck 11 of a bottle, for which it forms a substantially complementary shape. Furthermore, its upper end 90 includes two teeth 95 extending in the extension of the bottom 93 and side wings 92. According to the invention, the second element 9 further includes an axis 97 extending between its side wings 92 at its lower end 91.

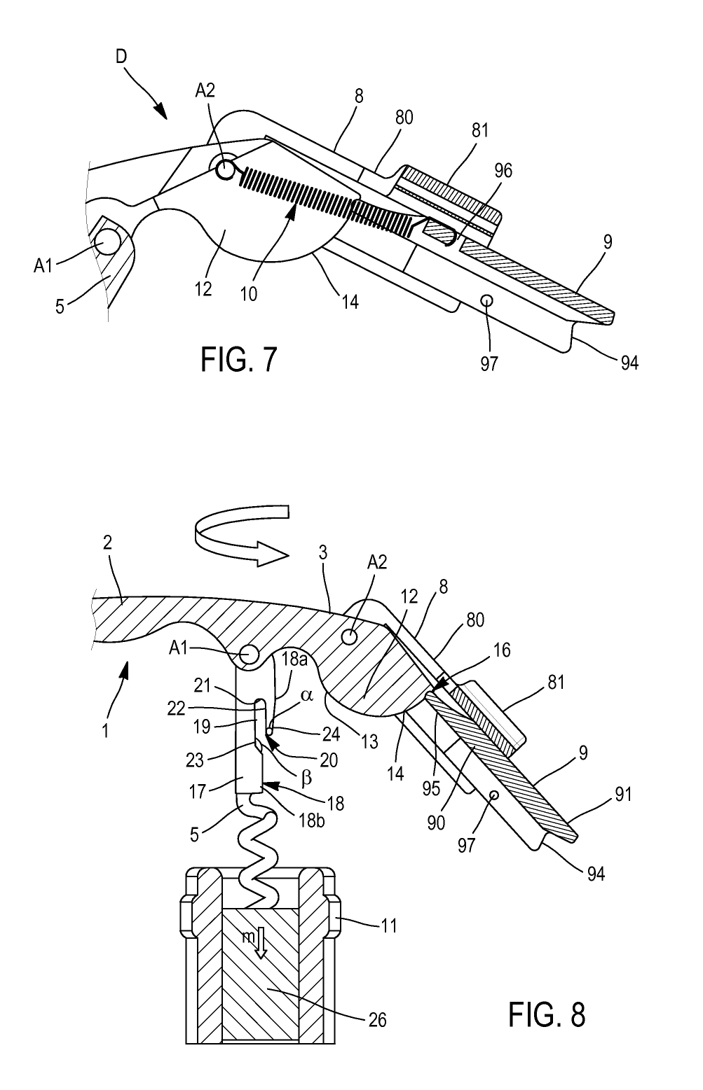

According to the invention, the second element 9 is mounted sliding in the first element 8, the side walls 84 of which define a guideway. The second element 9 is also connected to the second axis A2 of the telescoping arm 7 using an extension spring, for example a helical spring 10 (cf. FIG. 7), a first end of which is fastened to said axis A2 and a second end of which is fastened on the element 9, for example in a notch 96 included by the bottom 93 of the latter. According to another alternative embodiment that is not shown, it is also possible to provide for equipping the element 9 with an axis mounted between its surfaces 92 and on which the second end of the spring 10 can be fastened. In this case, said axis may be mounted sliding in an oblong aperture formed appropriately on a wall 84 of the element 8, and advantageously defining a maximal travel of the element 9 making it possible to avoid any untimely disassembly of the element 7 by pulling.

It should be noted that the second element 9 is mounted in the first element 8 and connected to the handle 2 using the spring 10 such that, in the usage position of the corkscrew 1, its teeth 95 are continuously kept in contact with the lower edge of the end segment 3 of the handle 2, while its lower end 91 is continuously located outside the first element 8. The stops 26 included by the first element 8 also contribute to keeping the lower end 91 of the second element 9 outside the first element 8.

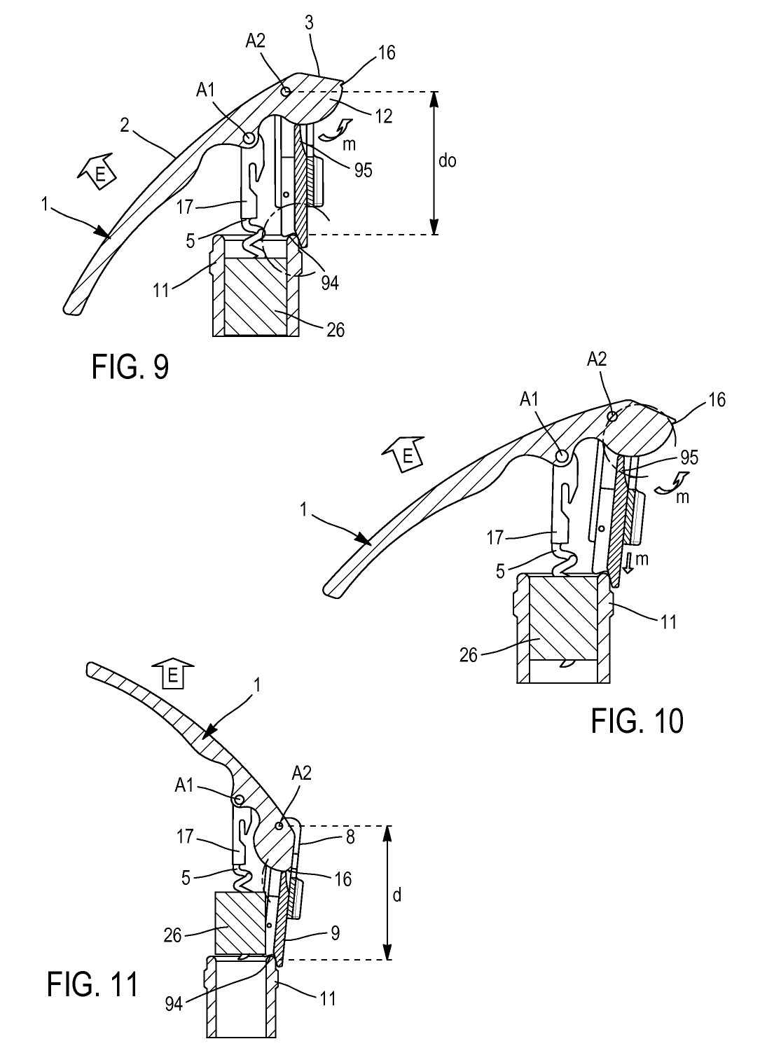

Indeed, in reference to the figures, the end segment 3 of the handle 2 defines a circular cam 12 having, as center, the second rotation axis A2. The invention provides that the profile of this cam 12 includes a first curve 13 with a constant radius and a second curve 14 with an increasing radius following one another between the intermediate zone 6 of the handle 2 bearing the first axis A1 and the end edge 15 of the end segment 3 of the handle 2. The cam profile 12 further includes a stop 16 formed in the extension of the curve of increasing radius 14. In fact, in the illustrated alternative embodiment, the circular cam 12 has two symmetrical members 12a, 12b (cf. FIG. 3) each in contact with a tooth 95 of the second element 9 of the telescoping arm 7. Thus, the cam 12 is able to act on the upper end 90 of the second element 9 in order to move the latter between an idle position which its lower edge 94 is located at a distance d0 from the second axis A2 and a second position in which the lower edge 94 is located at a distance d from the second axis A2 greater than d0 (cf. FIGS. 9 and 11).

The spiral 5 traditionally includes an upper part 17 with a rectangular section connected to the first axis A1 of the sleeve 2. It has a side face 18 (cf. FIGS. 4 and 8) oriented toward the telescoping arm 7. According to the invention, the upper part 17 is provided with a groove 19 with an axis parallel to the longitudinal axis of the spiral 5, and the inlet opening 20 of which is formed in its side face 18, dividing the latter into an upper zone 18a and a lower zone 18b. More particularly, in the illustrated alternative embodiment, the groove 19 has a U-shaped section and includes a bottom 21 delimited by a front wall 22 and a rear wall 23. The groove 19 is provided able to accommodate the axis 97 included by the second element 9 of the telescoping arm 7 in the storage position of the corkscrew 1. Furthermore, the front wall 22 is connected to the upper zone 18a of the side face 18 by an oblique surface 24 forming, with said front wall 22, an angle α smaller than 90°. The rear wall 23 of the groove 19 is in turn connected to the lower zone 18b of the side face 18 by an oblique surface 25 forming, with said rear wall 23, an angle β greater than 90° (cf. FIG. 8).

The particular structure of the upper part 17 of the spiral 5 and the presence of the axis 97 on the second element 9 of the telescoping arm 7 advantageously allow concomitant folding/unfolding of the spiral 5 and the arm 7. Indeed, the deployment/folding of the telescoping arm 7, obtained after its rotation around the axis A2 in one direction or the other, drives the movement of the spiral 5.

Thus, to unfold the spiral 5 and the arm 7, the user needs only pull on the arm 7 to deploy it (cf. FIG. 12). The axis 97 of the second element 9 of the arm 7 then slides in the groove 19 of the upper part 17 of the spiral 5, while bearing on the front wall 22 of said groove 19. This results in driving the spiral 5 gradually in the rotational movement of the telescoping arm 7 (cf. FIGS. 13-14). When the axis 97 of the second element 9 of the arm 7 reaches the inlet opening 20 of the groove 19, the spiral 5 is released from its contact with the arm 7 and places itself in the active, completely unfolded position owing to the action of the spring (not shown) connecting it 97 to the handle 2. Furthermore, at the end of deployment, the teeth 95 of the second element 9 of the arm 7 are placed in contact with the cam 12 of the handle 2, against the stop 16 (cf. FIG. 1).

In this position of the corkscrew 1, the user can then screw the spiral 5 into a cork 26 closing the neck 11 of a bottle by rotating the entire corkscrew 1 around the longitudinal axis of the spiral 5. The arm 7 advantageously remains blocked against the stop 16 throughout this entire operation under the effect of the force exerted by the user on the handle 2 (cf. FIG. 8) and therefore does not risk hindering the movements of the latter.

Owing to the invention, the user can next remove the cork 26 from the neck 11 with a reduced force. To that end, he first frees the telescoping arm 7 blocked against the stop 16 of the cam 12 of the handle 2 by pushing the maneuvering segment 4 of the latter downward toward the neck 11. He next positions the V-shaped lower edge 94 of the second part 9 of the telescoping arm 7 on the neck 11 of the bottle, which will allow him to bear on the latter subsequently. The position of the corkscrew 1 then obtained is illustrated in FIG. 9.

Through an upward pulling force on the maneuvering segment 4 of the handle 2, the user next removes the cork 26 gradually from the neck 11 in a single movement. The pulling force exerted then causes the arm 7 and the spiral 5 to rotate around their respective rotation axes A1, A2. The second part 9 of the arm 7, the teeth 95 of which are continuously kept in contact with the profile of the cam 12, under the effect of the spring 10, follows the rotational movement of the arm 7 during a first phase of the movement, its teeth 95 then being subject to the action of the first curve 13 with a constant radius of the cam 12 (cf. FIG. 10). Then, during the second phase of the removal movement, the teeth 95 of the second part 9 of the arm 7 come into contact with the second curve 14 with an increasing radius of the cam 12. The latter then bears on said second element 9 until causing it to move relative to the first element 8 toward its second position in which its lower edge 94 moves away from the axis A2 and the arm 7 is thus gradually lengthened over the course of the movement of the cam 12 relative to the arm 7 (cf. FIGS. 10-11).

The rotational and lengthening movement of the telescoping arm 7 is stopped by the arrival of the stop 16 of the cam 12 in contact with the teeth 95 of its second element 9. In this position of the corkscrew 1, the cork 26 is completely removed from the neck 11. In other words, to completely remove the cork 26 from the neck 11, it will have sufficed for a user to screw the spiral 5 into said cork 26, then to exert a single pulling force on the maneuvering segment 4 of the handle 2 after having positioned the arm 7 bearing on the neck 11.

Once the cork 26 is removed from the neck 11, the user traditionally pulls the spiral 5 and returns the corkscrew 1 to its storage position, in which the spiral 5 and the arm 7 are folded against its lower edge.

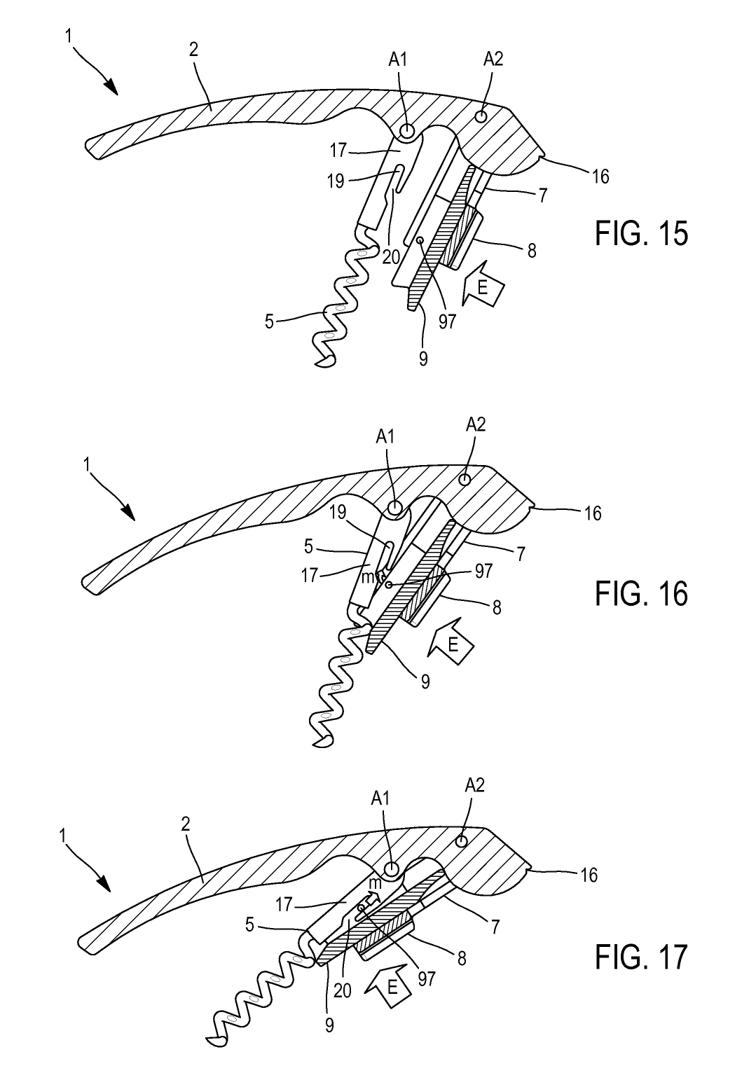

This last operation may be done in a single step, by concomitantly folding the spiral 5 and the arm 7, according to what is illustrated in FIGS. 15 to 17.

In this case, the user simply folds the telescoping arm 7, which comes into contact with the spiral 5, then causes it to rotate around the axis A1. The axis 97 of the arm 7, which is then placed below the inlet opening 20 of the groove 19, can then become housed directly inside the latter to next reach the bottom 21 thereof at the end of folding.

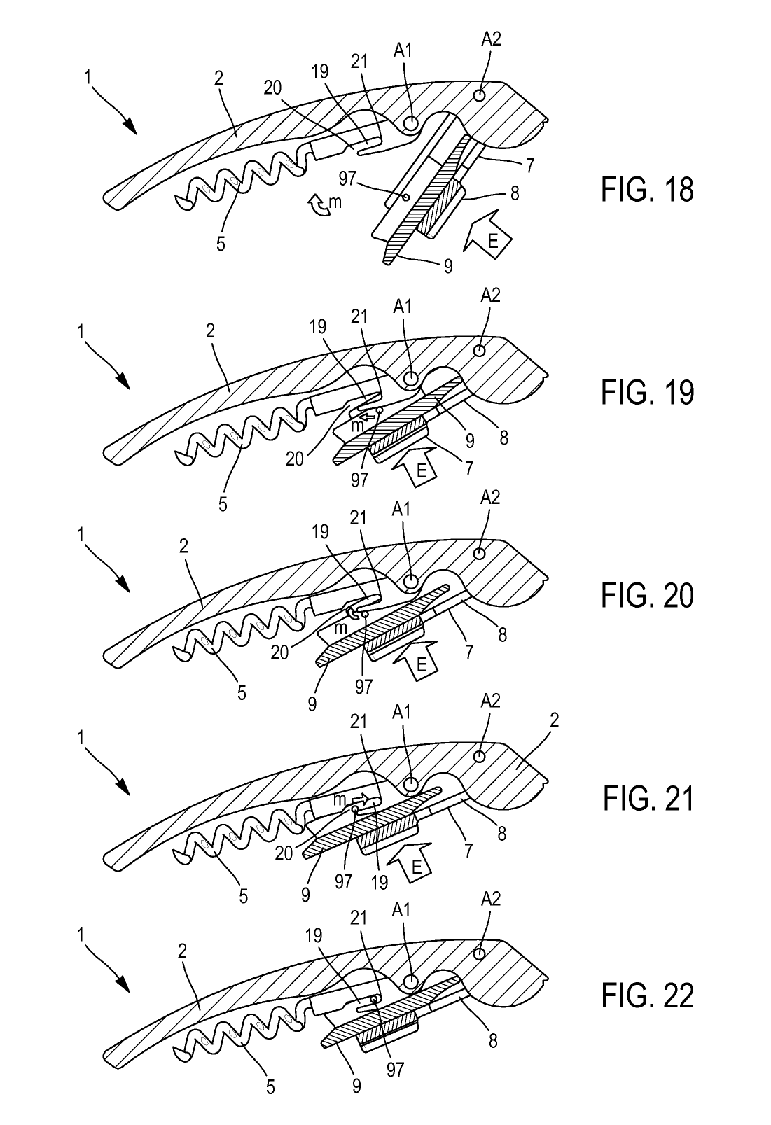

Naturally, the same operation can also be done in two steps by first folding the spiral 5, then the arm 7 (cf. FIGS. 18-22).

In this case, once the spiral 5 is folded, the axis 97 of the second part 9 of the arm 7 cannot be housed only directly in the groove 19 of the spiral 5, not being positioned appropriately across from the inlet opening 20 thereof. To achieve this, the user is forced to press the arm 7 against the spiral 5, which allows the axis 97 to come into contact with the oblique surface 24 extending between the upper zone 18a of the side wall 18 of the upper part 17 of the spiral 5 and the front wall 22 of the groove 19 (cf. FIG. 19). As the force is exerted by the user on the arm 7 toward the spiral 5, the second element 9 of the arm 7 moves along said oblique surface 24 and therefore relative to the first part 8 of the arm 7, causing the lengthening of the latter (cf. FIG. 20). In the location where the oblique surface 24 and the inlet opening 20 of the groove 19 meet, the axis 97 can be inserted into the groove 19 (cf. FIG. 21). Then, the second element 9 returns to its idle position, under the effect of the spring 10, fastened between the second element 9 of the arm 7 and the rotation axis A2, and allows the axis 97 to reach the bottom 21 of the groove 19 at the end of the folding (cf. FIG. 22).

1. A corkscrew with lever comprising:
a handle comprised of an end segment and a maneuvering segment;
a spiral mounted rotating on a zone of said handle between said end segment and said maneuvering segment, around a first axis perpendicular to said handle; and
a telescoping arm having a first element mounted rotating on the end segment around a second axis perpendicular to said handle and a second element, having an upper end and a lower end, mounted sliding in said first element between an idle position in which the lower edge of its lower end is located at a distance from said second axis) and a second position in which the lower edge of its lower end is located at a distance-d from said second axis greater than the distance from said second axis in said idle position, the lower edge of the lower end of said second element being provided able to bear on the neck of a bottle,
wherein said end segment defines a circular cam having, as center, said second axis and able to act on the upper end of said second element, which is connected to said second axis using a return member,
wherein, in a usage position, said upper end is continuously kept in contact with said cam and its lower end extends continuously outside said first element.

2. The corkscrew, according to claim 1, wherein a profile of said cam comprises a first curve with a constant radius and a second curve with an increasing radius following one another between the intermediate zone of the handle bearing the first axis and the end edge of the end segment.

3. The corkscrew according to claim 2, wherein said profile further comprises a stop formed in the extension of the second curve of increasing radius.

4. The corkscrew according to claim 1, wherein said return member is an extension spring.

5. The corkscrew according to claim 1, wherein the second element is comprised of a U-shaped section and two side wings bordering a bottom, the lower edge of each of said side wings having a V-shaped cutout able to bear on the neck of a bottle and the upper end of said second element being comprised of at least one tooth extending in the extension of said bottom and said side wings and bearing on said cam.

6. The corkscrew, according to claim 5, wherein said second element comprises a notch formed in at least one of its side wings and able to allow the fastening of said return member.

7. The corkscrew, according to claim 1, wherein said spiral has an upper part with a rectangular section connected to said first axis and a side face oriented toward said telescoping arm, said upper part being provided with a groove with an axis parallel to the longitudinal axis of the spiral and the inlet opening of which is formed in said side face.

8. The corkscrew, according to claim 7, wherein said groove has a U-shaped section being comprised of a bottom delimited by a front wall and a rear wall, and wherein said front wall is connected to an upper zone of said side face by an oblique surface forming, with said front wall, an angle α smaller than 90°.

9. The corkscrew, according to claim 7, wherein the rear wall of said groove is connected to a lower zone of the side face by an oblique surface forming, with said rear wall, an angle β greater than 90°.

10. The corkscrew, according to claim 7, wherein said second element of said telescoping arm comprises an axis extending between its side wings at its lower end.
